(19) United States
(12) Patent Application Publication
(10) Pub. No.: US 2014/0317255 A1
(43) Pub. Date: Oct. 23, 2014

(54) SYSTEM AND METHOD FOR FAST NETWORK DISCOVERY UPDATING AND SYNCHRONIZATION USING DYNAMIC HASHES AND HASH FUNCTION VALUES AGGREGATED AT MULTIPLE LEVELS

(71) Applicant: AVAYA INC., Basking Ridge, NJ (US)

(72) Inventor: Nishant Krishna, Gaya (IN)

(73) Assignee: Avaya Inc., Basking Ridge, NJ (US)

(21) Appl. No.: 13/864,414

(22) Filed: Apr. 17, 2013

(51) Int. Cl. H04L 12/24

(52) U.S. Cl. CPC H04L 41/12
USPC 709/223

(57) ABSTRACT

Embodiments disclosed herein provide systems and methods for hash based management of a communication network. In a particular embodiment, a method provides receiving a plurality of hashes for a plurality of network elements, wherein each hash of the plurality of hashes represents at least one attribute associated with at least one network element of the plurality of network elements and the plurality of hashes includes a first hash for a first network element of the plurality of network elements. After receiving the plurality of hashes, the method provides receiving a second hash for the first network element and determining whether the second hash matches the first hash. In response to determining that the second hash does not match the first hash, the method provides determining at least one attribute associated with the first network element.

### TECHNICAL BACKGROUND

Network management servers are attached to communication networks for network administration. In order to administer a network, a network management server determines characteristics of the network. The characteristics include attributes, such as hardware and software components, of network elements that are a part of and connected to the network. The network elements may include network gateways, servers, telephones, computers, or any other type of network connected devices.

To determine the attributes of each network element, a network management server determines which network addresses are associated with a network element. The network management system then uses the network addresses that are associated with network elements to communicate with those network elements to retrieve the attributes from each element. Each time the network management server performs an administration operation that requires knowledge of network element attributes, the network management server repeats this process to ensure the attributes are current. The more network elements, the longer it takes for the network management server to repeat the attribute determination process.

### Overview

Embodiments disclosed herein provide systems and methods for hash based management of a communication network. In a particular embodiment, a method provides receiving a plurality of hashes for a plurality of network elements, wherein each hash of the plurality of hashes represents at least one attribute associated with at least one network element of the plurality of network elements and the plurality of hashes includes a first hash for a first network element of the plurality of network elements. After receiving the plurality of hashes, the method provides receiving a second hash for the first network element and determining whether the second hash matches the first hash. In response to determining that the second hash does not match the first hash, the method provides determining at least one attribute associated with the first network element.

In some embodiments, the method provides that the first hash is generated using values for each of the at least one attributes associated with the first network element as inputs into a hash function.

In some embodiments, the method provides that the first network element receives a second at least one hash of the plurality of hashes for at least one other network element of the plurality of network elements and generates the first hash using the second at least one hash from the at least one other network element as inputs into a hash function.

In some embodiments, the method provides that determining at least one attribute associated with the first network element comprises determining whether the second at least one hash matches a first at least one hash of the plurality of hashes for the at least one other network element and, upon determining that the second at least one hash does not match the first at least one hash, determining the at least one attribute from attributes of the at least one other network element.

In some embodiments, the method provides that receiving the plurality of hashes comprises polling the plurality of network elements for the plurality of hashes.

In some embodiments, the method provides that receiving the plurality of hashes comprises receiving each of the plurality of hashes as the plurality of hashes are pushed to the network management system from the plurality of network elements.

In some embodiments, the method provides that the second hash is pushed to the network management system from the first network element upon generation of the second hash.

In some embodiments, the method provides, in response to determining that the second hash does not match the first hash, replacing the first hash in the plurality of hashes with the second hash.

In some embodiments, the method provides that, in response to determining that the second hash does not match the first hash, updating an attribute data structure for the plurality of network elements with the at least one attribute.

In some embodiments, the method provides that the plurality of network elements provides services using a plurality of protocols and the plurality of hashes are received using a protocol different than at least one of the plurality of protocols.

Another embodiment provides a network management server comprising an interface and a processing system. The interface is configured to receive a plurality of hashes for a plurality of network elements, wherein each hash of the plurality of hashes represents at least one attribute associated with at least one network element of the plurality of network elements and the plurality of hashes includes a first hash for a first network element of the plurality of network elements. The processing system is configured to, after receiving the plurality of hashes, receive a second hash for the first network element, determine whether the second hash matches the first hash, and, in response to determining that the second hash does not match the first hash, determine at least one attribute associated with the first network element.

### BRIEF DESCRIPTION OF THE DRAWINGS

FIG. 1 illustrates a network management system for hash based management of a communication network.

FIG. 2 illustrates an operation of the network management system for hash based management of a communication network.

FIG. 3 illustrates a network management system for hash based management of a communication network.

FIG. 4 illustrates an operation of the network management system for hash based management of a communication network.

FIG. 5 is a sequence diagram illustrating an operation of the network management system for hash based management of a communication network.

FIG. 6 is a sequence diagram illustrating an operation of the network management system for hash based management of a communication network.

FIG. 7 is a sequence diagram illustrating an operation of the network management system for hash based management of a communication network.

FIG. 8 illustrates a network management server for hash based management of a communication network.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

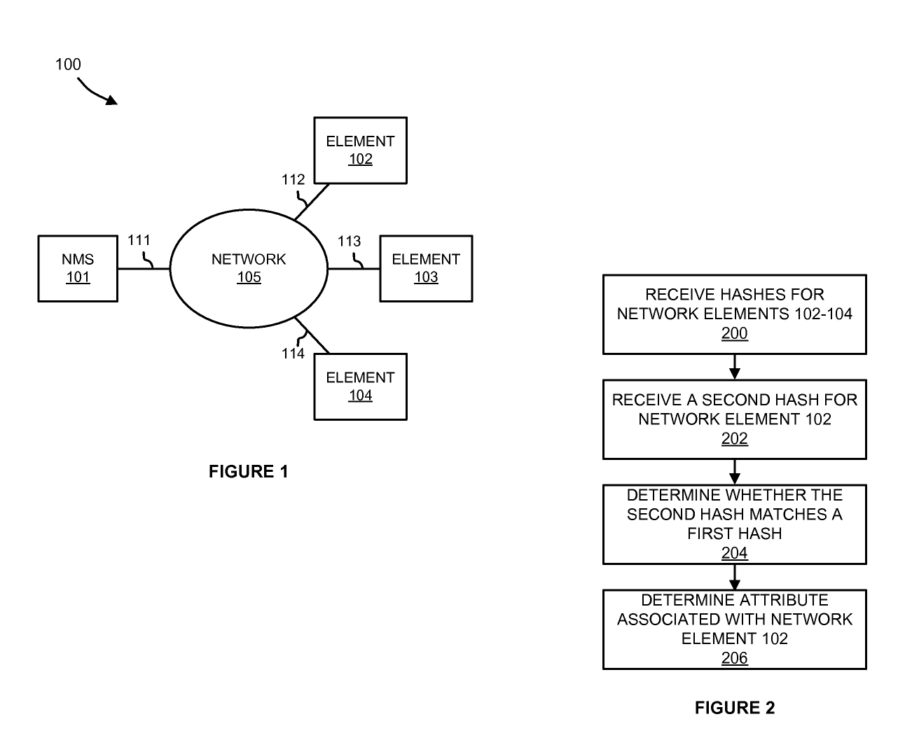

FIG. 1 illustrates network management system 100. Network management system 100 includes network management server 101, network elements 102-104, and communication network 105. Network management server 101 and communication network 105 communicate over communication link 111. Network elements 102-104 and communication network 105 communicate over communication links 112-114, respectively.

In operation, network management server 101 performs tasks for administering network 105, including network elements 102-104. In order to perform the administrative tasks network management server 101 may need to know characteristics of network 105. The characteristics of network 105 may include attributes of network elements of network 105, including hardware and software characteristics, such as model identifiers, software versions, performance settings, performance measurements, or any other possible attributes for network elements. Network management server 101 may use information about network element attributes to administer network 105 by adjusting parameters of the network elements based on the attributes. Network management server 101 may also compile the attribute information for presentation to a network administrator (user) so that the network administrator can be informed and make decisions about the administration of network 105.

In order to determine the attributes of network elements, network management server 101 may need to determine what network elements are located on network 105 and determine attributes of those network elements. For example, network management server 101 may check every possible network address, such as an IP address, on network 105 to determine whether a network element is located at each network address. For each network address that is determined to have a network element, network management server 101 performs a discovery process on the network element to determine attributes of that element. This process may be repeated periodically in order to determine whether network elements have been added to network 105, subtracted from 105, have changed attributes, or some other type of network element information. Especially in larger networks, each iteration of the process described above may take a large amount of time.

FIG. 2 illustrates an operation of network management system 100 for hash based management of a communication network. Network management server 101 receives hashes for network elements 102-104 (step 200). The hashes may be received from one or more of network elements 102-104 either by polling network elements 102-104 or by having elements 102-104 push the hashes to network management server 101, in a table (or other data structure) entered by a network administrator or received from another system, or any other way that a network management server may be able to receive values. Each hash represents at least one attribute associated with at least one of network elements 102-104. An attribute may be an element type, an element model designation, unique element identifier, software version, software setting, component designation, operational setting, operational measurement, or any other type of characteristic that a network element may have. In some embodiments, a hash is associated with an attribute by using a value representing that attribute as an input into a hash function that generated the hash. In some embodiments, inputs into a hash function may include hashes generated from one or more attributes of a network element or may include hashes of hashes as part of a network element hierarchy. For example, network element 102 may receive hashes from network elements 103 and 104 to use as inputs into the hash function rather than network management server 101 receiving the hashes from network elements 103 and 104 directly.

In some embodiments, in addition to receiving the hashes, network management server 101 may also receive attributes for each of network elements 102-104. The attributes may be received from one or more of network elements 102-104 either by polling network elements 102-104 as part of a attribute discovery process or by having elements 102-104 push the attributes to network management server 101, in a table (or other data structure) entered by a network administrator or received from another system, or any other way that a network management server may be able to receive attribute information. The attributes and/or the hashes may be stored in a memory/storage system located within network management server 101 or some other location that is accessible by network management server 101.

Included in the hashes is a first hash network element 102. After receiving the hashes, network management server 101 receives a second hash for network element 102 (step 202). The second hash may be received as part of another round of polling on network elements 102-103 or network element 102 may autonomously transfer or “push” the second hash to network management server 101. Network element 102 may autonomously transfer the second hash upon generating the second hash due to a change in one or more inputs to the hash function, such as a changed attribute value or changed hash.

Network management server 101 determines whether the second hash matches the first hash (step 204). The second hash will match the first hash if the inputs used in the hash function to generate the two hashes are the same. A hash function is a function that maps inputs (sometimes referred to as keys) into a hash value, which this disclosure refers to simply as a hash. The hash function will always result in the same hash value if the inputs to the hash function are the same. Accordingly, each attribute used when generating a hash value must be assigned a unique number so that all hash values generated from input sets with at least one different attribute result in different hash values. Likewise, the hash function used to generate the hash values should result in values of enough digits to ensure that each possible attribute set results in a different hash value. For example, a hash function that results in a single digit hash value would only support 10 different hash results, which would not work for a network having more than ten possible network element attribute combinations.

While each element has at least one hash computed from attributes of each respective element, some embodiments allow for at least a portion of the network elements to have more than one hash. For example, if network management server 101 is configured to separate software attributes from hardware attributes of elements 102-104, then separate hashes may be generated for software and hardware attributes. Thus, elements 102-104 will have a software attribute hash and a hardware attribute hash in addition to or as an alternative to a hash for all attributes of each element.

In accordance with the above discussed properties of hashes, if network management server 101 determines that the second hash matches the first hash, no inputs to the hash function used to generate the first and the second hash have changed in the time between receipt of the first hash and receipt of the second hash. However, if network management server 101 determines that the second hash does not match the first hash, then at least one input into the hash function has changed in the time between receipt of the first hash and receipt of the second hash.

Thus, in response to determining that the second hash does not match the first hash, network management server 101 determines at least one attribute associated with network element 102 (step 206). The at least one attribute is at least one attribute that changed in order to cause the hash function to generate the second hash that does not match the first hash. If one or more attributes for network element 102 are the inputs to the hash function, then network management server performs a discovery process on network element 102 to determine the at least one attribute from attributes of network element 102. If one or more hashes from other network elements make up the first and second hash, then network management system may have to perform further comparisons to determine which network element had attributes change to cause the progression of changed hashes ending in the second hash received for network element 102. In other words, the at least one attribute may be associated with network element 102 if the at least one attribute changed on an element lower in a hash hierarchy than network element 102.

Advantageously, using hashes in the manner described above, network management server 101 does not need to determine attributes of all network elements 102-104 in order to determine whether any attributes have changed. Rather, network management server 101 can compare new hashes received from network elements 102-104 to hashes already received from those elements and only determine attributes for elements that have changed hashes. It should be understood that, while only network elements 102-104 are illustrated and discussed for clarity, communication network 105 may include other network elements

Referring back to FIG. 1, network management server 101 comprises a computer processing system and communication interface. Network management server 101 may also include other components such a user interface, data storage system, and power supply. Network management server 101 may reside in a single device or may be distributed across multiple devices. Network management server 101 is shown externally to communication network 105, but server 101 may be considered an element of network 105. Similarly, the functionality of network management server 101 may be incorporated into another network element.

Network elements 102-104 each comprise wired and/or wireless communication circuitry. The communication circuitry may include an amplifier, filter, modulator, and signal processing circuitry. Network elements 102-104 may also include a user interface, memory device, software, processing circuitry, or some other communication components. Network elements 102-104 may each be a telephone, computer, e-book, mobile Internet appliance, wireless network interface card, wired network interface card, network access nodes, network gateway, network router, Internet access node, service node, media player, game console, or some other communication apparatus—including combinations thereof.

Communication network 105 comprises network elements, similar to and including network elements 102-104. Accordingly, communication network 105 may comprise switches, wireless access nodes, Internet routers, network gateways, application servers, computer systems, communication links, or some other type of communication equipment—including combinations thereof. Communication network 105 may be a single network, such a local area network (LAN), the Internet, or any other type of network, or may be a collection of networks and use multiple network protocols.

Communication links 112 uses metal, glass, air, space, or some other material as the transport media. Communication link 112 could use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication link 112 could be a direct link or may include intermediate networks, systems, or devices.

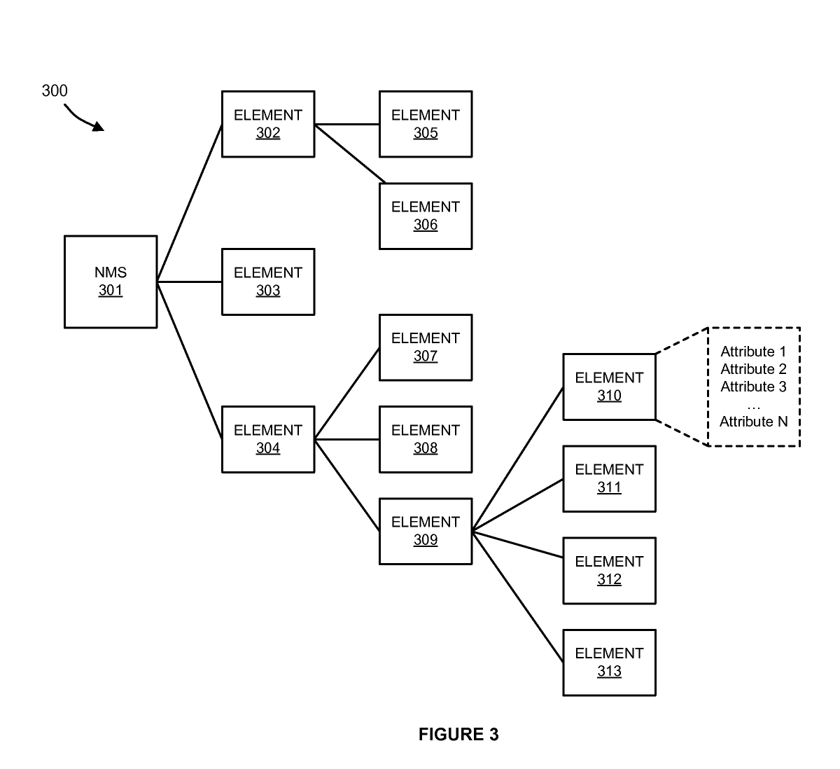

FIG. 3 illustrates network management system 300. Network management system 300 includes network management server 301 and network elements 302-314. While not explicitly illustrated, network elements 302-313 are part of and exchange communications over one or more communication networks or sub networks like communication network 105 illustrated in FIG. 1. Network elements 302-313 are illustrated in a hierarchal manner, although, network communication paths between any of the elements do not necessarily follow paths of the illustrated hierarchy. Network elements 302-313 may be arranged in a hierarchy for any reason, such as being a group of similar elements. For example, network elements 310-313 may be network telephones and network element 309 may be a server for those telephones.

Network management server 301 may use application layer protocols, such as Simple Network Management Protocol (SNMP), Windows Management Instrumentation (WMI), WebServices, or some other protocol, to exchange communications with network elements 302-313 and perform network administration, which may include the hash exchanges and attribute discovery discusses herein. The protocol used by network management server 301 may be the same as or different than a protocol used by the various network elements to provide network services. Using the networked telephones example from above, the protocol used by network element 309 to provide telephone services to network elements 310-313 may be a VoIP protocol while network elements 309-313 exchange administrative communications with network management server 301 using SNMP.

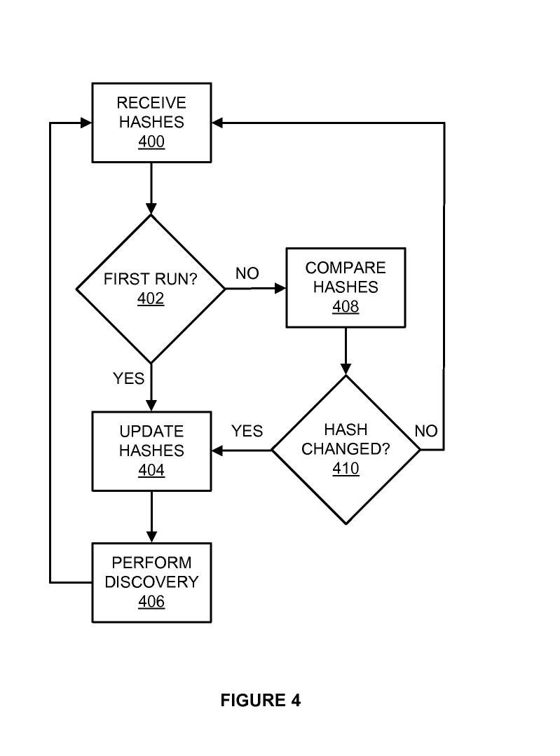

FIG. 4 illustrates an operation of network management system 300 for hash based management of a communication network. The operation begins with network management server 301 receiving hashes for network elements 302-313 (step 400). Each hash received by network management server 301 may represent attributes of a single network element or may be a hash of other hashes, as described above. A hash for an individual element includes attributes for that element as inputs into a hash function used to generating the hash. For example, FIG. 3 illustrates that network element 310 includes Attributes 1-N, although, some network elements may include more or fewer attributes than the attributes possessed by network element 311. The equation for computing the hash for network element 310 may therefore be computed as hash(element 310)=f(Attribute 1, Attribute 2, Attribute 3, . . . Attribute N).

Attributes 1-N are each represented by a value (i.e. a number) unique to the attribute so that another hash generated using the same attributes results in the same hash value (e.g. a particular version of an item of software is assigned a particular number across all network elements). A data structure on each network element may store values corresponding to each attribute or each network element may access a data structure stored elsewhere on the communication network to retrieve the attribute values. Each network element may compute its own hash using included processing circuitry or may receive the hash computed elsewhere. For example, a network technician installing or modifying the network element or the manufacturer of the network may input the hash into a memory of the network element.

The hashes may be received from the elements 302-313 themselves or may be received from elsewhere. For example, in some embodiments, if network management server 301 is receiving the hashes for the first time, the hashes may be provided by a network administrator, or some another network system, that has already compiled a data structure, such as a table, including the hashes.

If the hashes are received as part of a first run (step 402), then network management system 301 updates a data structure for storing hashes with the received hashes for future reference (step 404). A first run means that network management system 301 does not have other hashes with which to compare the received hashes, which may be the case when network management system 301 is newly implemented in the communication network. Thus, on a first run, no hashes will be stored in the data structure, therefore, updating the data structure may include creating the data structure and populating the data structure with the hashes.

Network management server 301 then performs a discovery process to determine the attributes of each network element 302-313 having a changed hash (step 406). In this first run iteration of the process, since all the hashes are new, all hashes are considered changed and network management system 301 performs attribute discovery on each of network elements 302-313. The attribute discovery process determines any attributes that network management server 301 may be able to use when administering the network. An attribute may be an element type, element model, element serial number, element component (or information related thereto), software type, software version, performance measurement, performance characteristic, or any other type of attribute. The attributes determined for an element in the discovery process are attributes whose values were used to generate the hash.

Once attributes of a network element are discovered, network management server 301 updates a data structure with the attributes (step 406). The data structure may be the same data structure that stores the received hashes. Similar to the situation with the hashes received on the first run, updating the data structure may include creating the data structure and populating the data structure with the attributes since no attributes were contained before. Therefore, after the discovery process, network management server 301 now maintains hashes for each of network elements 302-313 and attributes for network elements 302-313. For example, the process discovers Attributes 1-N of network element 310, network management server 301 stores those attributes as being attributes of element 310, and network management server 301 has a hash generated from those attributes stored in step 404 as well.

After this initial run, the operation returns to step 400 to receive one or more new hashes. The new hashes may be received as part of another round of polling network elements 302-313 for hashes, hashes may be transferred from elements 302-313 periodically, or a hash for an element may be transferred by that element upon the hash being updated.

Upon receiving the new hashes, network management server 301 determines that this is not the first run of the operation (step 402) and compares the new hashes to the hashes that are already stored in the data structure discussed above (step 408). The comparison is performed to determine whether the hash(es) received for a particular element matches the hash(es) previously stored for that element. For example, one of the hashes may be a hash from network element 310. If any of Attributes 1-N have changed since the stored hash was received, then the hash for network element 310 will not match.

Accordingly, a non-matching hash indicates to network management server 301 that at least one attribute of the network element associated with the hash has changed. Thus, upon determining that one or more hashes have changed (step 410), network management server 301 updates the hash data structure with the new hashes so that the new hashes are used in future comparisons (step 404). Likewise, network management server 301 performs the attribute discovery process on the network elements having the non-matching hashes and updates the attributes in the attribute data structure with the attributes discovered in the process (step 404). The operation then returns to step 400 in order to continue receiving new hashes so that network management server 301 can maintain the current attributes of network elements 302-313 without having to perform the attribute discovery process on network elements that have not changed attributes since the previous discovery was performed.

It should be understood that when a new network element is added to the network, the hash for that new element will not match an existing hash since there is no existing hash. Thus, network management server 301 will perform discovery on the new element. Similarly, if a network element is subtracted from the network then the new hash will either not exist or will otherwise indicate the absence of an element. Accordingly, the new hash in those cases will not match and, if the new hash itself does not indicate the absence of a network element, discovery performed on the subtracted element will indicate to network management server 301 that the element has been removed.

In some embodiments, additional network management servers may exist and the hashes received from the network elements are shared between those network management servers. The hashes may be stored on a common database or may be shared from a database local to each network management server.

In further embodiments, the hashes may be stored in network devices, such as routers and gateways, so as to allow the hashes to be readily accessible from those devices if the hashes are not otherwise accessible from the network element(s). Accordingly, network management server 301 may be able to retrieve a hash for a network element from the network devices on a path to the network element regardless of the path that is taken.

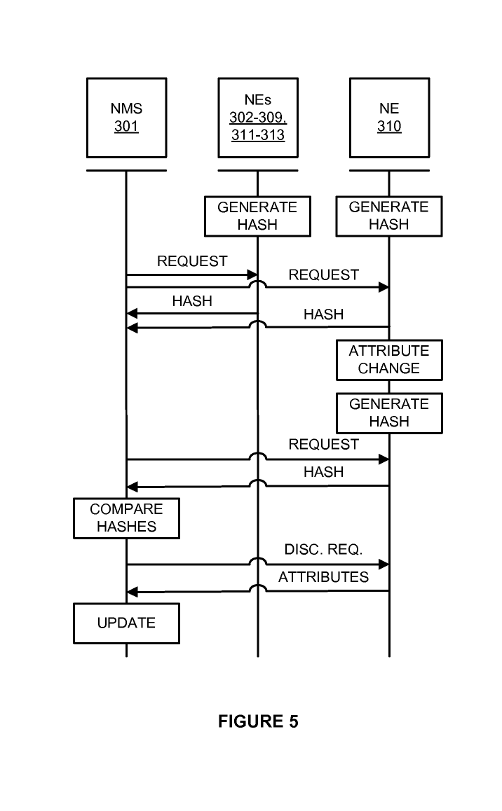

FIG. 5 is a sequence diagram illustrating an operation of network management system 300 for hash based management of a communication network in an exemplary embodiment. Network element 310 is separated from the other network elements for exemplary purposes but the other network elements will perform similarly to network element 310. In accordance with a first run for network management server 301 to receive hashes, network elements 302-313 generate hashes using values for their respective attributes and network management server 301 polls network elements 302-313 for those hashes. To poll the network elements, network management server 301 transfers a request for the hashes to each of network elements 302-313. Although shown before the request is received, network elements 302-313 may generate the hashes in response to receiving the requests.

At a time after transferring those hashes to network management server 301, one or more of Attributes 1-N of network element 310 are changed (i.e. modified, added, or subtracted). Therefore, network element 310 generates a new hash using values for Attributes 1-N of network element 310 after the change. Since at least one of the attribute values has changed in this example, the hash generated from those values will be different than the hash previously calculated for network element 310. Network management server 301 transfers a request for the new hash to network element 310. Although shown before the request is received, network element 310 may generate the new hash in response to receiving the hash request. Additionally, though not shown, network management server 301 may also transfer hash requests to the other network elements as part of another round of polling.

Network element 310 transfers the requested hash to network management server 301 and network management server 301 compares the new hash to the hash previously received from network element 310. In this example, the hash has changed so network management server 301 recognizes that at least one attribute of network element 310 has changed. Thus, network management server 301 transfers a discovery request to network element 310. In response to the discovery request, network element 310 transfers attribute information to network management server 310. Network management server 301 updates the attribute information stored for network element 310 and updates the hash for network element 310. Upon completion of discovery, network management server 301 is now up to date on the attributes of network element 310 and has stored a new hash that can be used in further iterations of the hash polling process to determine whether any attributes of network element 310 change again.

If any other network elements were found to have non-matching hashes, then network management server 301 performs the attribute discovery process on those elements as well. Network management server 301 does not perform the attribute discovery process on network elements with matching hashes because those network elements have not changed attributes. Therefore, even though network management server 301 will still poll all elements for hashes, network management server 301 does not need to discover attributes for all the network elements unless all of the respective hashes have changed.

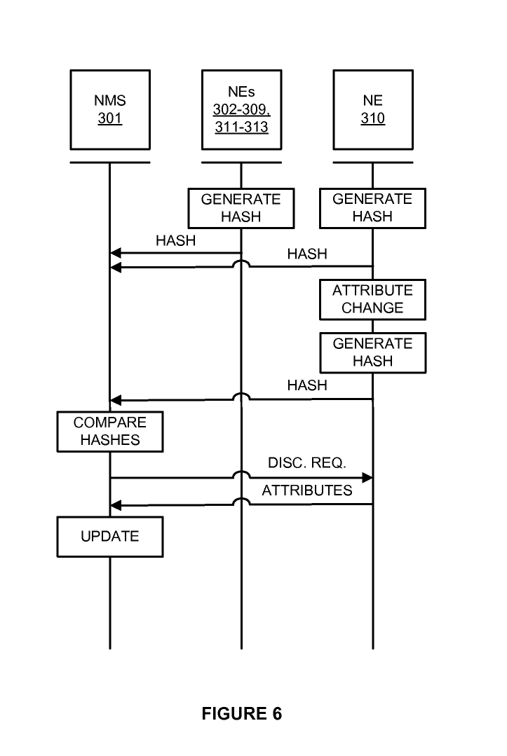

FIG. 6 is a sequence diagram illustrating an operation of network management system 300 for hash based management of a communication network in an exemplary embodiment. Network element 310 is separated from the other network elements for exemplary purposes but the other network elements will perform similarly to network element 310. In accordance with a first run for network management server 301 to receive hashes, network elements 302-313 generate hashes using values for their respective attributes and, upon generating the hashes, each network element automatically transfers the hashes to network management server 301. This process may also be referred to as pushing or publishing the hashes to network management server 301.

In this embodiment, since network elements 302-313 are configured to push hashes to network management server 301, network management server 301 does not need to poll the network elements for the hashes. Therefore, upon one or more of Attributes 1-N of network element 310 being changed (i.e. modified, added, or subtracted), network element 310 generates a new hash using values for Attributes 1-N of network element 310 after the change. Network element 310 then automatically transfers that new hash to network management server 301 where the hash is compared to the hash previously received by network management server 301 for network element 310.

Since the hash has changed in this example, network management server 301 recognizes that at least one attribute of network element 310 has changed. Thus, network management server 301 transfers a discovery request to network element 310. In response to the discovery request, network element 310 transfers attribute information to network management server 310. Network management server 301 updates the attribute information stored for network element 310 and updates the hash for network element 310. Upon completion of discovery, network management server 301 is now up to date on the attributes of network element 310 and has stored a new hash that can be used in further iterations of the process to determine whether any attributes of network element 310 change again.

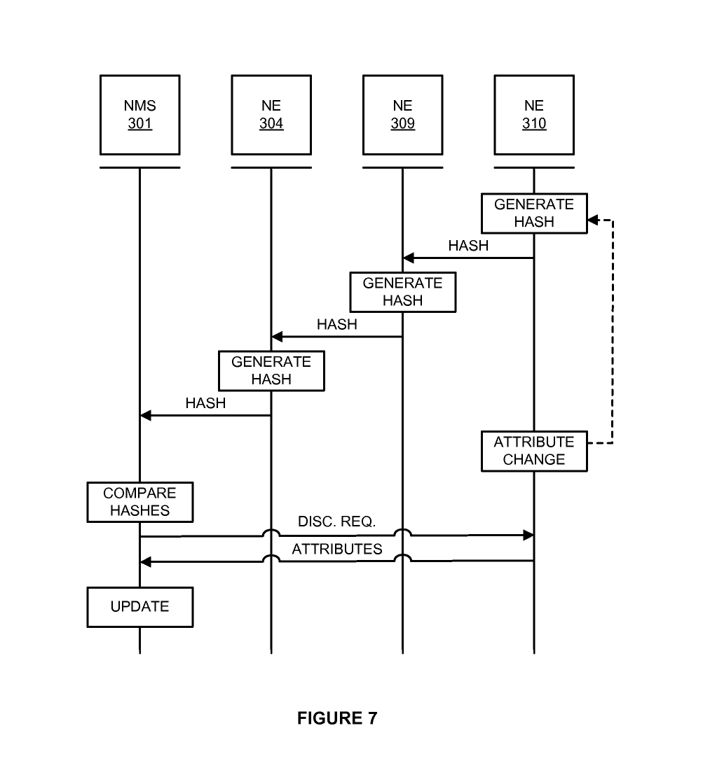

FIG. 7 is a sequence diagram illustrating an operation of network management system 300 for hash based management of a communication network in an exemplary embodiment. Network element 310 is separated from the other network elements for exemplary purposes but the other network elements will perform similarly to network element 310. In this embodiment, the network element hierarchy is used to generate hashes at each level rather than a hash for every network element.

Network elements lower in the hierarchy transfer hashes to network elements that are a level above in the hierarchy. Network elements 310-313 transfer hashes to network element 309, network elements 309-309 transfer hashes to network element 304, network elements 305-306 transfer hashes to network element 302, and network elements 302-304 transfer hashes to network management server 301. Thus, network management server 301 may receive a little as three hashes, one from each of network elements 302-304.

In a particular example illustrated in FIG. 7, network element 310 generates a hash of Attributes 1-N and transfers that hash to network element 309. While no request is shown, network element 310 may transfer the hash automatically or as part of a polling process by network element 309. Network element 309 also receives hashes generated from attributes of network elements 311-313. Network element 309 then uses the four hashes received from elements 310-313 to generate new hash. For example, the equation for computing the hash for network element 309 may therefore be computed as hash(element 309)=f(hash(element 310), hash(element 311), hash(element 312), hash(element 313)). This new hash may further be generated with attributes of network element 309 as inputs or a separate hash may be generated for attributes of network element 309. Thus, the equation above may further include a hash for the attributes of network element 309 as an input to generate the hash that will be transferred from network element 309 to an element higher in the hierarchy.

Network element 309 then transfers the new hash (and, if created, the separate hash for the attributes of element 309) to network element 304. Network element 304 further receives hashes from network elements 307-308 and uses the hashes from elements 307-309 as inputs to generate a new hash. As was the case with network element 309 this new hash may further be generated with attributes of network element 304 as inputs or a separate hash may be generated for attributes of network element 304.

Network element 304 then transfers the new hash (and, if created, the separate hash for the attributes of element 304) to network management server 301. Network management server 301 compares the received hashes to determine whether any attributes have changed from a previous run. Since each individual network element did not transfer a hash directly to network management server 301, network management server 301 does not need to compare hashes for every element. Rather, if an attribute changes in a lower element in the hierarchy, then the change will consequently change all the hashes in the hierarchal chain. Thus, if network management server 301 determines that a hash received from network elements 302-304 hash changed, then network management server 301 can narrow down the element causing the change by navigating down through the hierarchy.

For example, if an attribute changes in network element 310, a hash received by network management server 301 from network element 304 will change. Upon determining that a hash received from network element 304 has changed, network management server 301 may request the hashes that network element 304 received from network elements 307-309 to determine which of network elements 304 and 307-309 caused the change. Network management server 301 may also perform an attribute discovery on network element 304 to determine whether network element 304 caused the changed hash. Upon determining that network element 309 also has a changed hash, network management server 301 may request the hashes that network element 309 received from network elements 310-313 to determine which of network elements 309 and 310-313 caused the change. Network management server 301 may also perform an attribute discovery on network element 309 to determine whether network element 309 caused the changed hash. Network management server 301 then determines that network element 310 has one or more changed attributes and requests attribute discovery from network element 310. Network management server 301 then updates the attributes stored for network element 310 with the attributes received from network element 310 in the attribute discovery. Conversely, if no attribute has changed for any element under network element 304 in the hierarchy, then the hash received from network element 304 will not change and network management server 301 will know that no element in network element 304's branch of the hierarchy has changed attributes.

In the embodiment described above, in order to determine which elements have changed hashes at each level, network management server 301 may receive hashes from all elements as part of a first run and then update those hashes as network management server 301 drills down in the hierarchy to find the network element that caused the change. Alternatively, network elements in the hierarchy may be configured to store hashes and perform comparisons at each level so that network management server 301 can simply query each network element in the hierarchy for which element caused the changed hash at that level. Regardless, in either case, network management server 301 will only need to compare the hashes received from the highest level elements 302-304 to determine whether attributes for any network elements have changed rather than comparing hashes for all elements. Especially in situations where no attributes have changed, performing fewer comparisons saves time for network management server 301.

Advantageously, the use of hashes in a hierarchal configuration, as described above, reduces not only the network data needed to determine attributes for every network element but also the network data needed to retrieve the hashes as well. Moreover, the benefit is even greater if any of the network elements are located through firewalls and/or proxies because network management server 101 will not need to go through those firewalls or proxies to retrieve attribute information unless the attributes have changed.

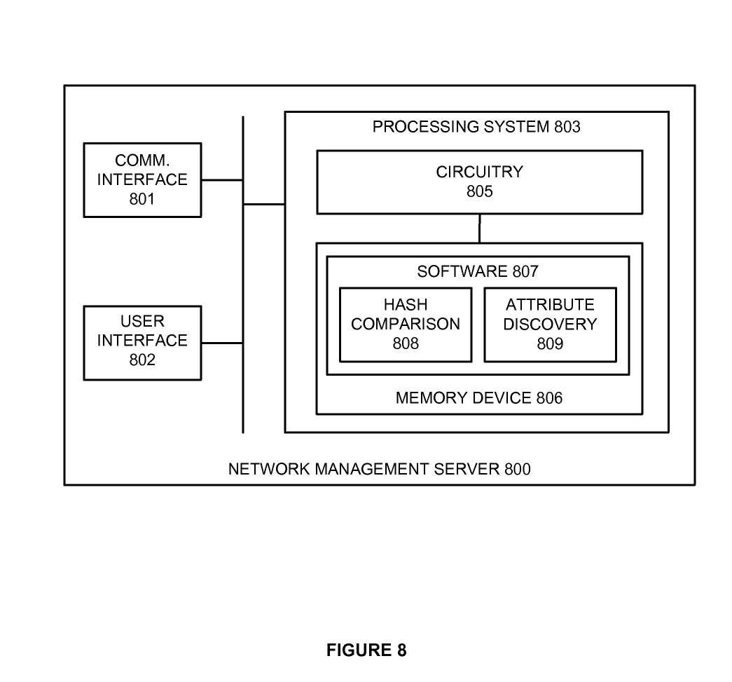

FIG. 8 illustrates network management server 800. Network management server 800 is an example of network management server 101, although server 101 may use alternative configurations. Network management server 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a non-transitory storage medium, such as a disk drive, flash drive, data storage circuitry, or some other memory apparatus. Operating software 807 comprises computer programs, firmware, or some other form of machine-readable processing instructions. Operating software 807 includes hash comparison module 808 and attribute discovery module 809. Operating software 807 may further include an operating system, utilities, drivers, network interfaces, applications, or some other type of software. When executed by circuitry 805, operating software 807 directs processing system 803 to operate network management server 800 as described herein.

In particular, hash comparison module 808 directs processing system 803 to receiving a plurality of hashes for a plurality of network elements, wherein each hash of the plurality of hashes represents at least one attribute associated with at least one network element of the plurality of network elements and the plurality of hashes includes a first hash for a first network element of the plurality of network elements. The plurality of hashes may be received via communication interface 801 or user interface 802. After receiving the plurality of hashes, hash comparison module 808 directs processing system 803 to receive a second hash for the first network element and determine whether the second hash matches the first hash. In response to determining that the second hash does not match the first hash, attribute discovery module 809 directs processing system 803 to determine at least one attribute associated with the first network element.

It should be understood that the methods described herein may be applied to other types of management systems that monitor attributes of various nodes, whatever those nodes may be. Examples of other management systems to which the hashing features described above could apply include Element Management Systems (EMS), Business Management Systems (BMS) and Service Management Systems (SMS).

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a network management system, comprising:
receiving a plurality of hashes for a plurality of network elements, wherein each hash of the plurality of hashes represents at least one attribute associated with at least one network element of the plurality of network elements and the plurality of hashes includes a first hash for a first network element of the plurality of network elements;
after receiving the plurality of hashes, receiving a second hash for the first network element;
determining whether the second hash matches the first hash; and
in response to determining that the second hash does not match the first hash, determining at least one attribute associated with the first network element.

2. The method of claim 1, wherein the first hash is generated using values for each of the at least one attributes associated with the first network element as inputs into a hash function.

3. The method of claim 1, wherein the first network element receives a second at least one hash of the plurality of hashes for at least one other network element of the plurality of network elements and generates the first hash using the second at least one hash from the at least one other network element as inputs into a hash function.

4. The method of claim 3, wherein determining at least one attribute associated with the first network element comprises:
determining whether the second at least one hash matches a first at least one hash of the plurality of hashes for the at least one other network element;
upon determining that the second at least one hash does not match the first at least one hash, determining the at least one attribute from attributes of the at least one other network element.

5. The method of claim 1, wherein receiving the plurality of hashes comprises:
polling the plurality of network elements for the plurality of hashes.

6. The method of claim 1, wherein receiving the plurality of hashes comprises:
receiving each of the plurality of hashes as the plurality of hashes are pushed to the network management system from the plurality of network elements.

7. The method of claim 6, wherein the second hash is pushed to the network management system from the first network element upon generation of the second hash.

8. The method of claim 1, further comprising:
in response to determining that the second hash does not match the first hash, replacing the first hash in the plurality of hashes with the second hash.

9. The method of claim 1, further comprising:
in response to determining that the second hash does not match the first hash, updating an attribute data structure for the plurality of network elements with the at least one attribute.

10. The method of claim 1, wherein the plurality of network elements provides services using a plurality of protocols and the plurality of hashes are received using a protocol different than at least one of the plurality of protocols.

11. A network management server, comprising:
an interface configured to receive a plurality of hashes for a plurality of network elements, wherein each hash of the plurality of hashes represents at least one attribute associated with at least one network element of the plurality of network elements and the plurality of hashes includes a first hash for a first network element of the plurality of network elements;
a processing system configured to, after receiving the plurality of hashes, receive a second hash for the first network element, determine whether the second hash matches the first hash, and, in response to determining that the second hash does not match the first hash, determine at least one attribute associated with the first network element.

12. The network management server of claim 11, wherein the first hash is generated using values for each of the at least one attributes associated with the first network element as inputs into a hash function.

13. The network management server of claim 11, wherein the first network element receives a second at least one hash of the plurality of hashes for at least one other network element of the plurality of network elements and generates the first hash using the second at least one hash from the at least one other network element as inputs into a hash function.

14. The network management server of claim 13, wherein to determine at least one attribute associated with the first network element, the processing system is configured to:
determine whether the second at least one hash matches a first at least one hash of the plurality of hashes for the at least one other network element;
upon determining that the second at least one hash does not match the first at least one hash, determine the at least one attribute from attributes of the at least one other network element.

15. The network management server of claim 11, wherein to receive the plurality of hashes, the interface is configured to:
poll the plurality of network elements for the plurality of hashes.

16. The network management server of claim 11, wherein to receive the plurality of hashes, the interface is configured to:
receive each of the plurality of hashes as the plurality of hashes are pushed to the network management server from the plurality of network elements.

17. The network management server of claim 16, wherein the second hash is pushed to the network management server from the first network element upon generation of the second hash.

18. The network management server of claim 11, further comprising:
the processing system configured to, in response to determining that the second hash does not match the first hash, replace the first hash in the plurality of hashes with the second hash.

19. The network management server of claim 11, further comprising:
the processing system configured to, in response to determining that the second hash does not match the first hash, update an attribute data structure for the plurality of network elements with the at least one attribute.

20. The network management server of claim 11, wherein the plurality of network elements provides services using a plurality of protocols and the plurality of hashes are received using a protocol different than at least one of the plurality of protocols.
